(19) United States
(12) Patent Application Publication
(10) Pub. No.: US 2012/0227209 A1
(43) Pub. Date: Sep. 13, 2012

(54) BALANCED HARNESS FOR BACKPACK VACUUM APPLIANCE

(75) Inventor: Richard W. VINSON, Idaho City, ID (US)

(73) Assignee: EMERSON ELECTRIC CO., St. Louis, MO (US)

(21) Appl. No.: 13/045,862

(22) Filed: Mar. 11, 2011

(51) Int. Cl. A47L 9/00; B23P 19/04; A47L 9/10; A45F 3/14

(52) U.S. Cl. 15/339; 224/259; 29/428

(57) ABSTRACT

A harness system for a backpack appliance may include a base, a waist support, a support member coupled to the base and adapted to couple to the appliance, and at least one shoulder strap. The shoulder strap may have a first end coupled to the base and a second end configured to couple to the appliance. The base may be configured to couple with the appliance. A method of supporting an appliance on a user may include coupling the appliance to a harness system, disposing a coupler adjacent a position on the user's back, and supporting the appliance with a support member in a pendulumlike manner. The pendulum may have a rest position, and the method may include biasing the appliance toward the rest position.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The invention disclosed and taught herein relates generally to support systems for vacuum appliances; and more specifically relates to backpack harness systems that center a vacuum appliance on a user's back.

2. Description of the Related Art

Appliances and other tools that are carried on a user's back are common in the commercial cleaning and maintenance market. Back-mounted, or backpack-style, machines are commonly constructed by attaching some fixed-shape machine to a flexible harness worn by the user so that some or all of the weight of the machine is supported by the user's back and shoulders. Some backpack harnesses for such applications commonly include shoulder straps, waist belts, straps, and so forth to help support the appliance about the user's body. Other backpack harnesses include only waist belts or straps and do not include shoulder supports. It is presently common for harnesses to include a waist belt, two separate shoulder straps, and a front tie strap that can connect the shoulder straps. Any of these straps and supports may optionally include one or more individual adjustments, such as to length, for accommodating operator size and facilitating operator comfort. Further, the industry has over time improved the materials and padding used with these devices in an effort to increase operator comfort and safety. Although the present invention can be used in numerous applications, such as for blowers, water jets, painters, sprayers, or other tools capable of being supported on a user's back, it is described herein with respect to a vacuum appliance application for illustrative purposes.

Backpack vacuum appliances, such as wet/dry or work area vacuum cleaners, are common in today's cleaning market and have been in the market for over twenty years. These systems may include a vacuum appliance attached to a harness worn by the user so that some or all of the appliance is disposed behind the user adjacent the user's posterior, or back. For example, U.S. Patent Publication No. 2009/0095780 to Wangeby et al., the entirety of which is incorporated herein by reference, purports to disclose a harness for a backpack vacuum cleaner including a back plate mounted to a vacuum cleaner body. Backpack vacuum appliances may typically include components such as powerheads, vacuum bodies, debris containers, filters, hoses, vacuum tool attachments and so forth, any or all of which may amount to an appliance having significant weight. Present appliances typically support the vacuum weight via two separate shoulder straps each offset from the centerline of the weight, or the center of gravity, of the vacuum. Such a configuration can result in an uneven distribution of the vacuum appliance weight about the back of the user, particularly if each shoulder strap is not of the same length. This, as well as other perceived reasons for discomfort, such as a complexity of adjustments that can make balancing and even weight distribution difficult and time consuming, can result in an aversion to backpack appliances in cleaning operators and other users.

The invention disclosed and taught herein is directed to an improved harness system for supporting an appliance in a central location on a user's back.

### BRIEF SUMMARY OF THE INVENTION

A harness system for a backpack appliance may include a base having front and rear sides, an upper portion, and a lower portion, a waist support coupled to the base, a support member having a first end coupled to the base and a second end configured to couple to the appliance, and at least one shoulder strap, which may have a first end coupled to the base and a second end configured to couple to the appliance. The rear side of the base may be configured to couple with the appliance.

The harness system may include a coupler coupled to a portion of the base and the shoulder strap first end may be coupled to the coupler. The system may include a second support member having a first end coupled to the coupler and a second end coupled to the base. One or more support members may be formed integrally from a single member. One or more support members may be flexible straps. At least one support member may be a tension support member and may carry at least a portion of an appliance weight when an appliance is coupled to the harness system. The system may include a plate configured to couple to the appliance. At least one end of a support member, such as a shoulder strap or other member, may be coupled to the plate. At least one support member may form a pendulum that pivots about a point, junction, or other pivot, such as an end of a support member.

A backpack appliance system may include an appliance having any number of components, such as a vacuum appliance having a motor, a collector, an inlet, an outlet and a filter, and a harness system, wherein the appliance may be coupled to the harness system. The appliance system may include a support member that supports at least a portion of a weight of the appliance in tension, a coupler, one or more shoulder straps, and a second support member having an end coupled to the coupler and an end coupled to a portion of a base of the harness system.

The second support member may support at least a portion of a weight of the appliance in tension. The first and second support members may be formed integrally from a single member. One or more support members may be flexible straps. The harness system may include a plate configured to couple to the appliance. At least one end of a support member, such as a shoulder strap or other member, may be coupled to the plate. A support member and at least a portion of the appliance may form a pendulum that pivots about an end of the support member.

A method of supporting a backpack appliance on a user may include coupling the appliance to a harness system, disposing a coupler adjacent a position on the user's back, and supporting at least a portion of a weight of the appliance with a support member so that the support member and at least a portion of the appliance form a pendulum about an end of the support member. The pendulum may have a rest position, and the method may include biasing the appliance toward the rest position.

### BRIEF DESCRIPTION OF THE SEVERAL VIEWS OF THE DRAWINGS

FIG. 1 is a perspective view of one of many embodiments of a harness system utilizing certain aspects of the present invention.

FIG. 2 is an exploded perspective view of the harness system of FIG. 1.

FIG. 3 is a rear view of the harness system of FIGS. 1-2.

FIG. 4 is a rear perspective view of one of many embodiments of a harness system coupled to a vacuum appliance and utilizing certain aspects of the present invention.

FIG. 5 is a partial rear view of the harness system of FIG. 4.

FIG. 6 is a partial rear view of another of many embodiments of a harness system coupled to a vacuum appliance and utilizing certain aspects of the present invention.

FIG. 7 is a partial rear view illustrating the pendulumlike support of one of many embodiments of a harness system coupled to an appliance and utilizing certain aspects of the present invention.

### DETAILED DESCRIPTION OF THE INVENTION

The Figures described above and the written description of specific structures and functions below are not presented to limit the scope of what Applicant has invented or the scope of the appended claims. Rather, the Figures and written description are provided to teach any person skilled in the art to make and use the invention for which patent protection is sought. Those skilled in the art will appreciate that not all features of a commercial embodiment of the invention are described or shown for the sake of clarity and understanding. Persons of skill in this art will also appreciate that the development of an actual commercial embodiment incorporating aspects of the present invention will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the invention disclosed and taught herein is susceptible to numerous and various modifications and alternative forms. The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. As used herein, the term “may” means “may, but need not”, and the term “can” means “can, but need not”, unless otherwise indicated, and the terms “may” and “can” have the same meaning. The terms “including” and “such as” are illustrative and not limitative.

Applicant has created a support system for centering a backpack appliance, such as a backpack vacuum appliance, on a user's back. The system may generally include a harness for coupling the appliance to the user and for biasing the appliance toward a central position on the user's back as the user moves about during use. The harness may generally include structure for coupling with the vacuum appliance and structure for coupling with the user. The harness may include any number of support members, such as shoulder straps, tie straps, waste straps, and the like, any one or more of which may be adjustable in any manner. In at least one embodiment, the harness may preferably include at least one support member coupled in tension between the harness and the appliance and disposed along a weight centerline, as will be further described below.

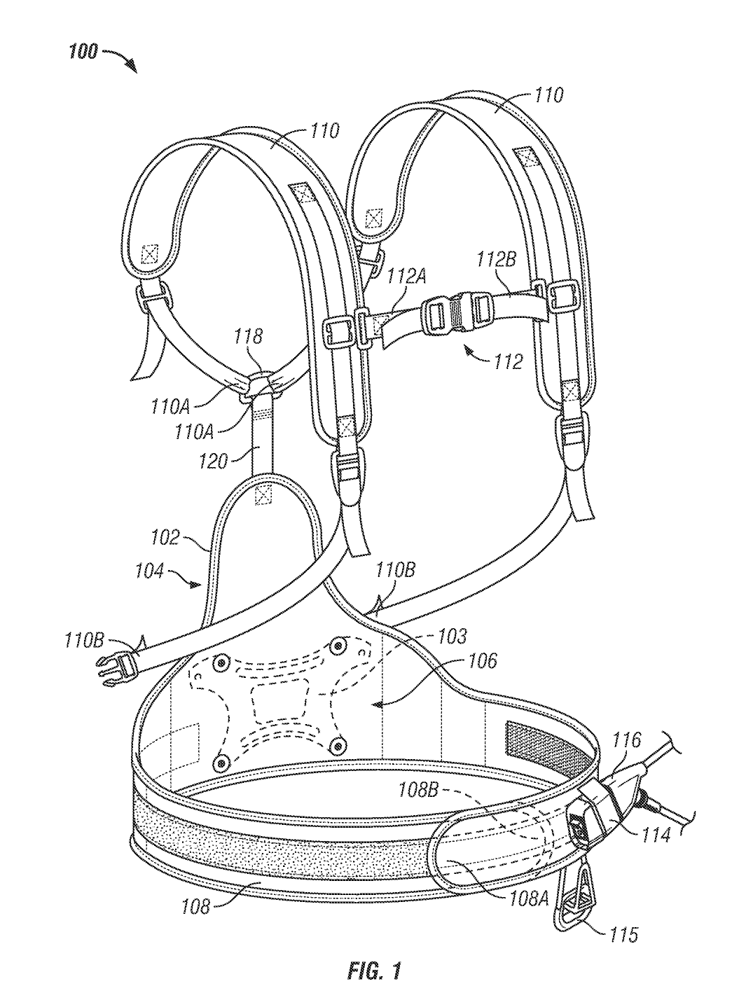

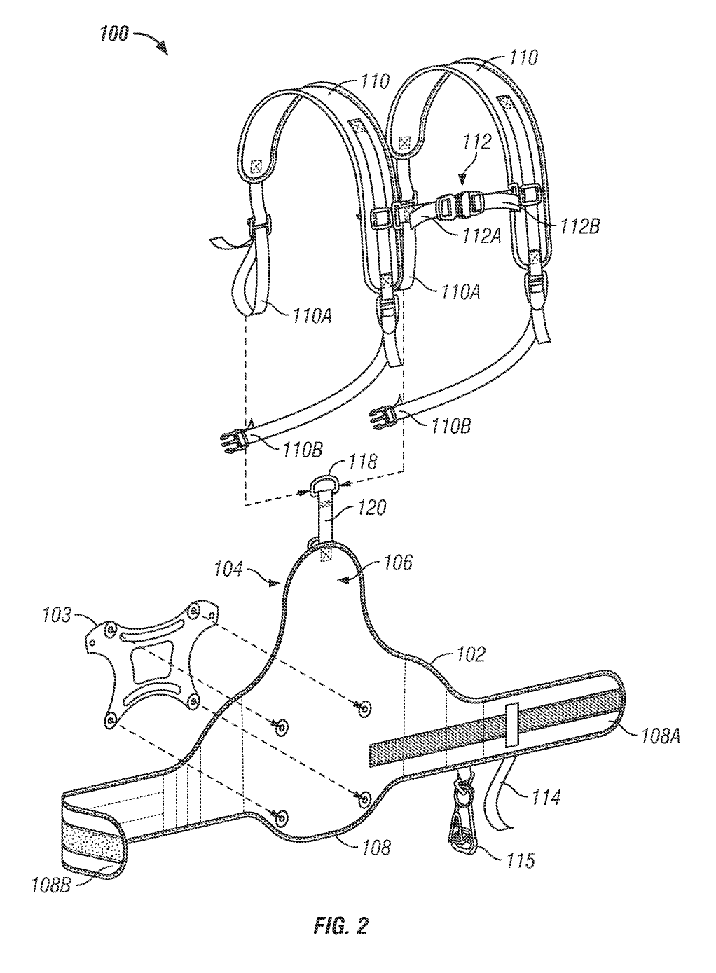

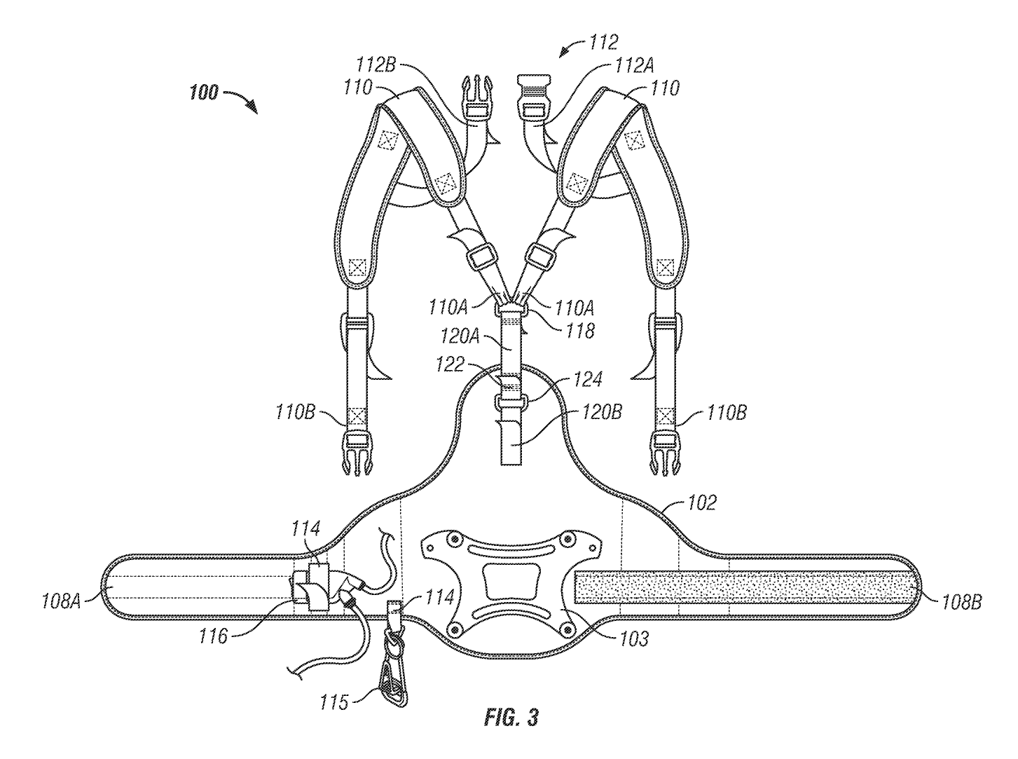

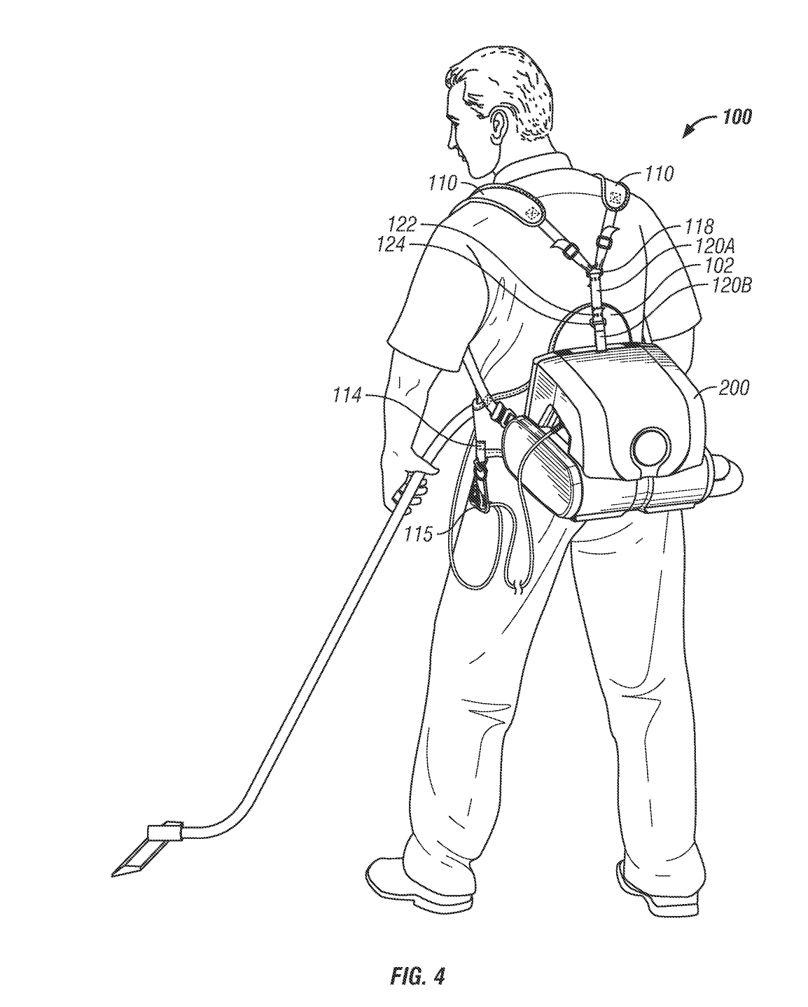

FIG. 1 is a perspective view of one of many embodiments of a harness system 100 utilizing certain aspects of the present invention. FIG. 2 is an exploded perspective view of the harness system 100 of FIG. 1. FIG. 3 is a rear view of the harness system 100 of FIGS. 1-2. FIGS. 1-3 will be described in conjunction with one another. Harness system 100 may generally include a base 102, such as a pad, belt, foundation, or other support member, for supporting an appliance about a user, for example, adjacent the user's back. Base 102 may be flexible or rigid, soft or hard, separately or in combination, as required by a particular application. For example, in at least one embodiment, base 102 may be made from flexible fabric, and may include one or more relatively rigid structures, such as one or more plates 103, for added support or strength. Plate 103 may be coupled with base 102 in any manner required by a particular application, including being disposed inside of base 102, in whole or in part, and may be any size. Base 102 may have a rear side 104 for coupling to a backpack appliance, such as, for example, vacuum appliance 200 (see FIG. 4), and a front side 106 which may be disposed adjacent the user. In at least one embodiment, plate 103 may be coupled to the rear side 104 of base 102. System 100 may preferably include a waist support 108 for coupling around a user's mid-section, or waist. Waist support 108 may include two ends 108A, 108B that couple with one another, directly or otherwise, such as in front of the user's waist, to at least partially support the system about the user's body. System 100 may include at least one shoulder support, such as a shoulder strap 110, for coupling with a user's shoulder to at least partially support the system, and may preferably include two shoulder straps 110, as shown in FIGS. 1-3 for illustrative purposes. Each shoulder strap 110 may have a first end, such as upper end 110A, for coupling with base 102, and a second end, such as lower end 1108, for coupling to another component of the system, which may be any component, and which may preferably be vacuum appliance 200 (see FIG. 4). System 100 may include one or more front supports, such as tie strap 112, for coupling shoulder straps 110 with one another, for example, in front of the user adjacent the user's chest or mid-section. Tie strap 112 may include one or more sections, and, in at least one embodiment, may preferably include two sections 112A, 1128 that removably couple with one another. One or more of sections 112A, 1128 can be coupled to a respective shoulder strap 110, for example, so that each section can slide along at least a portion of shoulder strap 110 (e.g., vertically as shown in FIGS. 1-2) for purposes such as fit, comfort, adjustability, accommodating users of various sizes, and like purposes. System 100 may include one or more accessory supports, such as pockets, straps, couplers or other supports, for example, accessory strap 114 or accessory coupler 115, for coupling any number or type of accessories to base 102. Such accessories may include appliance tools, hoses, cords, switches, electronics, vacuum tool ends, brushes, squeegees, or other accessories required by a particular application. As shown in the exemplary embodiment of FIGS. 1-3, which is but one of many, accessory strap 114 may support a power switch 116, such as an on/off toggle switch, for turning an appliance on and off as needed during use. As other examples, one or more accessory straps or couplers may be used to dispose one or more components of the system about a user, such as to route fluid hoses or electrical cords in a convenient manner, for example, so as to not get in the way of the user during operation of an appliance. One or more components of system 100, such as base 102, support 108, or shoulder straps 110, may include padding, contours, or other attributes commonly used in the art for purposes of user comfort during use. System 100 may include buckles, snaps, hook and loop material, hinges, hooks, or other fasteners known in the art, such as for adjusting one or more components of the system to fit a particular user in a desired manner, which can be any manner required by a particular application. One or more components of system 100, such as base 102, support 108, or shoulder straps 110 may be adjustable, such as in length, tightness, tension, or otherwise, for like purposes. The components of system 100 may be coupled permanently or removably.

With continuing references to FIGS. 1-2, and with specific reference to FIG. 3, system 100 may include one or more couplers 118 for coupling vacuum appliance 200 (see FIG. 4) to the system, separately or in combination with one or more other system components, as further described below. Coupler 118 may be any type of coupler required by a particular application, and may preferably include a joint or juncture for allowing a plurality of support members to communicate with one another for biasing an appliance toward a preferred position on a user's back, which can be any position required by a particular application, such as a centered position, as further described herein. Coupler 118, shown as a D-ring in FIGS. 1-3 for illustrative purposes, can include a ring, plate, junction, or any other coupler capable of performing the functions described herein, as will be readily understood by one of ordinary skill having the benefits of the present disclosure. Further, although coupler 118 can be a unitary component, it need not be, and may alternatively be part of one or more other components of the system, such as of base 102 or shoulder straps 110. As shown in the exemplary embodiment of FIGS. 1-3, coupler 118 may be coupled to at least one of shoulder straps 110, and may preferably be coupled to the upper end 110A of each. System 100 may include one or more supports, such as a back support 120, for coupling coupler 118 to vacuum appliance 200 (see FIG. 4). Back support 120 may be a single member, or alternatively may include a plurality of support members coupled to one another, whether directly or to one or more intervening components of system 100, as further described below. Shoulder straps 110, coupler 118 and back support 120 may cooperate to dispose one or more components of system 100 in a particular location on a user's back during use, such as adjacent to, or in-line with, an imaginary axis, for example an appliance weight centerline, or an axis passing at least substantially through a point located relative to the appliance, such as a center of gravity (CG) of all or a portion of the appliance.

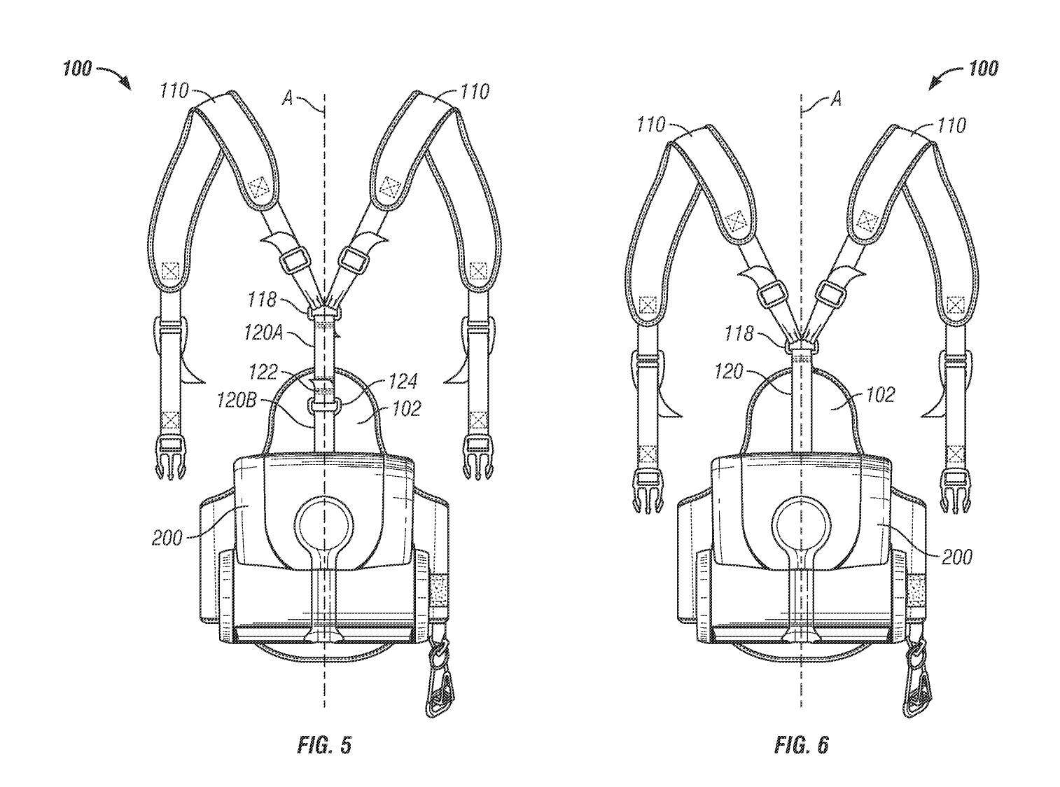

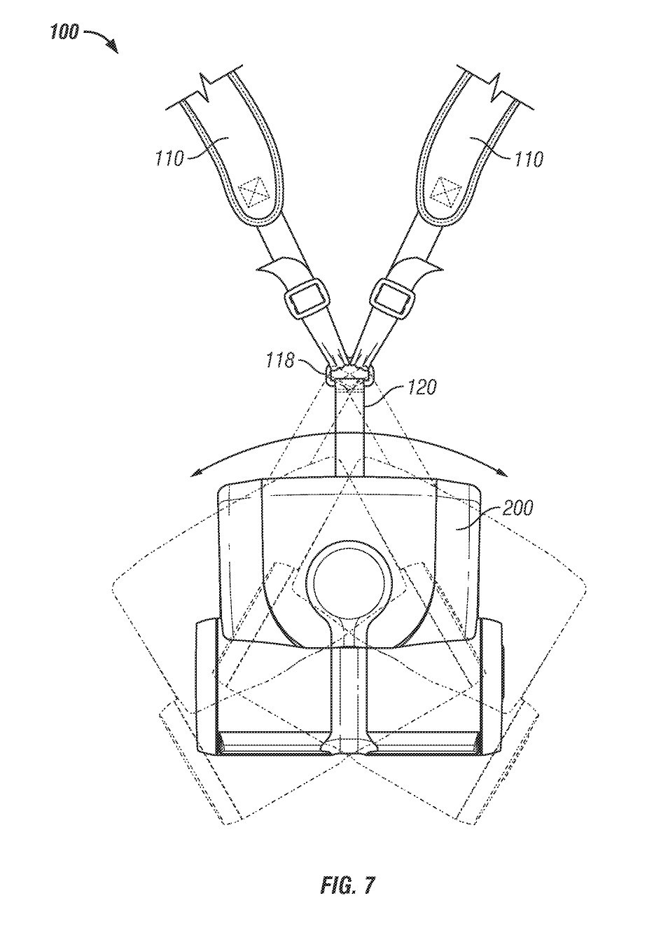

FIG. 4 is a rear perspective view of one of many embodiments of a harness system 100 coupled to a vacuum appliance 200 and utilizing certain aspects of the present invention. FIG. 5 is a partial rear view of the harness system 100 of FIG. 4. FIG. 6 is a partial rear view of another of many embodiments of a harness system 100 coupled to a vacuum appliance 200 and utilizing certain aspects of the present invention. FIG. 7 is a partial rear view illustrating the pendulumlike support of one of many embodiments of a harness system 100 coupled to an appliance 200 and utilizing certain aspects of the present invention. FIGS. 4-7 will be described in conjunction with one another. As shown in the embodiment of FIGS. 4-5, for example, support 120 may include a first member, such as upper back strap 120A, for coupling between coupler 118 and base 102, and a second member, such as lower back strap 120B (collectively “support 120”), for coupling between base 102 and vacuum appliance 200. Each back strap 120A, 120B may be coupled to a coupling point 122 on base 102, which may include a coupler, such as ring 124, or another coupler. Alternatively, coupling point 122 need not include ring 124, and support 120 may, for example, pass through point 122, such as through an opening or hole (not shown) in, or coupled to, base 102. As another alternative, support 120 may be a single member coupled intermediately to base 102 at point 122, such as by sewing or another manner of coupling, thereby forming straps 120A, 120B, as will be readily understood by one of ordinary skill having the benefits of the present disclosure. As yet another alternative, coupler 118 may be coupled directly to base 102 or plate 103 (see, e.g., FIG. 3), separately or in combination, and support 120 may include one or more members coupled between coupler 118 and appliance 200 (see FIG. 6). In such an embodiment, which is but one of many, shoulder straps 110 may be coupled more directly to base 102, such as to coupler 118 or plate 103, and upper back strap 120A may be absent.

System 100 may be adjustable, such as by adjusting the length of one or more components, to dispose vacuum appliance 200 in a particular location about the user, which may be any location. System 100 may preferably be configured so that vacuum appliance 200 is at least substantially centered about a user's back when, for example, the user is standing in a straight and upright position (represented by Axis A in FIG. 5), arbitrarily referred to herein as the “rest position” for ease of explanation and understanding. Axis A may be located anywhere about a user relative to the user or system 100. For example, Axis A may be a vacuum weight centerline, such as by passing on or near a CG of the appliance or another component of the system. As another example, Axis A may bisect the user, the appliance, or another component of the system. As the user moves about, such as during operation of vacuum appliance 200, harness system 100 may bias appliance 200 toward the rest position, for example, in a pendulumlike manner about coupling point 122. For example, support 120 and shoulder straps 110 may cooperate to keep coupler 118 on or near Axis A, such as adjacent a user's back or spine, which may thereby at least partially resist or limit side-to-side movement of appliance 200. The pendulumlike action may bias at least a portion of appliance 200, such as a top portion, toward Axis A as appliance 200 moves from side-to-side during use, such as due to momentum from the weight of appliance 200, which bias may occur separately or in combination with any bias resulting from appliance 200 being coupled to base 102 in one or more locations. Therefore, it can be seen that in at least one embodiment of system 100, such as the embodiments shown in FIGS. 4-6, which are but some of many, although a portion of appliance 200 may be at least substantially fixed in place relative to base 102, such as a portion disposed adjacent to plate 103 (not shown) or a lower portion, another portion of appliance 200, such as an upper portion, may be at least partially free to move, for example, in a pendulumlike motion about an equilibrium position. At least a portion of appliance 200 may be biased toward the rest position, such as by support 120 or one or more other components of system 100, separately or in combination, which may include being biased on or toward one or more axes or planes required by a particular application. The pendulumlike support and function described above are illustrated conceptually in FIG. 7, and will be readily understood by one of ordinary skill in the art having the benefits of the present disclosure.

While the harness system has many applications, the system is described herein with respect to a vacuum cleaner application for illustrative purposes. It should be noted that the term “support” and iterations thereof are used broadly herein and specifically include without limitation holding, affecting, sustaining, disposing, communicating with, or otherwise being related to. As used herein, support may include being coupled to or bearing the weight of, in any manner or degree, but need not, and may alternatively include positioning, uncoupling, releasing, or other types of support required by a particular application. The term “pendulum” and like terms are used broadly herein for point of clarity and should not be interpreted restrictively. It will be understood that positional terms such as “first,” “second,” “up,” “down,” and like terms have been used arbitrarily herein and for purposes of illustration. The positions described and shown herein may include any position required by a particular application, and may be held in any order and in any number. As will also be understood by one of ordinary skill having the benefits of the present disclosure, phrases such as “the same,” “substantially the same,” and like terms or phrases are used broadly herein, and may, but need not include identicalness.

Other and further embodiments utilizing one or more aspects of the invention described above can be devised without departing from the spirit of Applicant's invention. For example, the harness system may have any required capacity and may be coupled with any device or machine able to be supported on or about a user. Further, the various methods and embodiments of the system can be included in combination with each other to produce variations of the disclosed methods and embodiments. Discussion of singular elements can include plural elements and vice-versa. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, the Applicant intends to fully protect all such modifications and improvements that come within the scope or range of equivalents of the following claims.

What is claimed is:

1. A harness system for a backpack vacuum appliance, comprising:
a base having front and rear sides, an upper portion, and a lower portion;
a waist support coupled to the lower portion of the base;
a first support member having a first end coupled to the upper portion of the base and a free second end configured to couple to the vacuum appliance rearward of the base; and
a pair of shoulder straps, each having a first end coupled to the upper portion of the base and a free second end configured to couple to the vacuum appliance rearward of the base;
wherein the rear side of the base is configured to couple with the vacuum appliance.

2. The system of claim 1, further comprising a coupler coupled to the upper portion of the base, wherein the shoulder strap first ends are coupled to the coupler.

3. The system of claim 1, further comprising:
a coupler, the shoulder strap first ends being coupled to the coupler; and
a second support member having a first end coupled to the coupler and a second end coupled to the upper portion of the base.

4. The system of claim 3, wherein the first and second support members are formed integrally from a single member.

5. The system of claim 1, wherein the first support member is a flexible strap.

6. The harness system of claim 1, wherein the first support member is a tension support member, and wherein the tension support member carries at least a portion of a weight of the vacuum appliance when the vacuum appliance is coupled to the harness system.

7. The harness system of claim 1, wherein the base further comprises a plate configured to couple to the vacuum appliance.

8. The harness system of claim 7, wherein at least one of the first ends of the first support member and the pair of shoulder straps is coupled to the plate.

9. The harness system of claim 1, wherein the first support member forms a pendulum that pivots about the first end of the first support member.

10. A backpack vacuum appliance system, comprising:
a vacuum appliance having an electric vacuum motor, a debris collector, an air inlet, an air outlet, and a filter fluidicly coupled between the air inlet and the air outlet; and
a harness system as claimed in claim 1;
wherein the vacuum appliance is coupled to the rear side of the base; and
wherein the second end of the first support member is coupled to the vacuum appliance.

11. The vacuum appliance system of claim 10, wherein the first support member supports at least a portion of a weight of the vacuum appliance in tension.

12. The vacuum appliance system of claim 10, further comprising:
a coupler, the shoulder strap first ends being coupled to the coupler; and
a second support member having a first end coupled to the coupler and a second end coupled to the upper portion of the base;
wherein the second support member supports at least a portion of a weight of the vacuum appliance in tension.

13. The vacuum appliance system of claim 12, wherein the first and second support members are formed integrally from a single member.

14. The vacuum appliance system of claim 10, wherein the first support member is a flexible strap.

15. The vacuum appliance system of claim 10, wherein the base further comprises a plate, and wherein the first end of the first support member is coupled to the plate.

16. The vacuum appliance system of claim 10, wherein the first support member and at least a portion of the vacuum appliance form a pendulum that pivots about the first end of the first support member.

17. A method of supporting a backpack vacuum appliance on a user, comprising:
coupling the vacuum appliance to a harness system as claimed in claim 1;
disposing the coupler adjacent a centered position on the user's back; and
supporting at least a portion of a weight of the vacuum appliance with the first support member so that the first support member and at least a portion of the vacuum appliance form a pendulum about the first end of the first support member.

18. The method of claim 17, wherein the pendulum has a rest position, the method further comprising biasing the vacuum appliance toward the rest position.
